(19) United States
(12) Patent Application Publication
(10) Pub. No.: US 2021/0086648 A1
(43) Pub. Date: Mar. 25, 2021

(54) CHARGING SYSTEM FOR ELECTRIC VEHICLES

(71) Applicant: YU-SHUN LIN, Taichung City (TW)

(72) Inventor: YU-SHUN LIN, Taichung City (TW)

(21) Appl. No.: 16/681,882

(22) Filed: Nov. 13, 2019

(30) Foreign Application Priority Data
Sep. 23, 2019 (TW) 108212519
Oct. 28, 2019 (TW) 108138864

(51) Int. Cl. B60L 53/63; H02J 7/02; H02J 7/34; B60L 50/60; B60L 53/66; B60L 58/12; B60L 50/71; B60L 50/75

(52) U.S. Cl. CPC B60L 53/63; H02J 7/02; H02J 7/34; B60L 50/75; B60L 53/66; B60L 58/12; B60L 50/71; B60L 50/66

(57) ABSTRACT

A charging system for electric vehicles is provided, which may include a charging circuit module, a spare battery and a controller. The charging circuit module may be coupled to a utility power source. The spare battery may be coupled to the charging circuit module. The controller may control the utility power source and the spare battery via the charging circuit module.

### CROSS REFERENCE TO RELATED APPLICATION

All related applications are incorporated by reference. The present application is based on, and claims priority from, Taiwan Application No. 108138864, filed on Oct. 28, 2019, and Taiwan Application No. 108212519, filed on Sep. 23, 2019, the disclosures of which are hereby incorporated by reference herein in their entirety.

### TECHNICAL FIELD

The technical field relates to a charging system, in particular to a charging system for electronic vehicles.

### BACKGROUND

A currently available electric vehicle can be charged by a utility power source (utility power socket) in the user's house after connecting to the utility power source via an adapter or be charged via the official charging facility provided by the original manufacturer of the electric vehicle.

The power company transmits electric power to the AC equipment of the official charging facility and then the electric vehicle can be charged by the charger of a charging station in the official charging facility. For example, if the charging station with fast-charging function can fully charge an exhausted rechargeable battery (100D) in one hour, the power provided by the charger of the charging station should be 100 khr. Thus, the charging current is up to 545.5 A. Therefore, if the official charging facility needs 10 charging stations, the total charging current is up to 5455 A. Accordingly, the official charging facility not only needs to apply for a special electrical license, but also is hard to obtain enough power supply; moreover, the official charging facility also needs extremely high power supply capacity, which significantly increase the cost of the official charging facility.

Besides, the current provided by the utility power source is about 50 A˜80 A. Therefore, if the user charges the electric vehicle by the utility power source in the user's house, the user will spend a lot of time (several hours or more than 10 hours) fully charging the electric vehicle, which is extremely inefficient.

Furthermore, if the user drives the electric vehicle to a remote district without power supply facility, the user cannot charge the electric vehicle, which is very inconvenient in use.

### SUMMARY

An exemplary embodiment of the disclosure relates to a charging system for electric vehicles, which may include a charging circuit module, a spare battery and a controller. The charging circuit module may be coupled to a utility power source. The spare battery may be coupled to the utility power source. The controller may control the utility power source and the spare battery via the charging circuit module.

Another exemplary embodiment of the disclosure relates to a charging system for electric vehicles, which may include a charging circuit module, a fuel battery, a fuel storage tank and a fuel converter. The fuel battery may be coupled to the rechargeable battery of a target object via the charging circuit module in order to charge the rechargeable battery of the target object. The fuel storage tank may be coupled to the fuel battery and supply the fuel to the fuel battery. The fuel converter may be configured to convert a raw fuel material into the fuel and supply the fuel to the fuel battery.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

FIG. 1 is a block diagram of a charging system for electric vehicles in accordance with a first embodiment of the disclosure.

FIG. 2 is a schematic view of the charging system for electric vehicles in accordance with the first embodiment of the disclosure.

FIG. 3 is a block diagram of a charging system for electric vehicles in accordance with a second embodiment of the disclosure.

FIG. 4 is a schematic view of the charging system for electric vehicles in accordance with the second embodiment of the disclosure.

FIG. 5 is a block diagram of a charging system for electric vehicles in accordance with a third embodiment of the disclosure.

FIG. 6-FIG. 8 are a first schematic view, a second schematic view and a third schematic view of the charging system for electric vehicles in accordance with the third embodiment of the disclosure respectively.

FIG. 9 is a block diagram of a charging system for electric vehicles in accordance with a fourth embodiment of the disclosure.

FIG. 10 is a schematic view of the charging system for electric vehicles in accordance with the fourth embodiment of the disclosure.

### DETAILED DESCRIPTION

In the following detailed description, for purposes of explanation, numerous specific details are set forth in order to provide a thorough understanding of the disclosed exemplary embodiments. It will be apparent, however, that one or more exemplary embodiments may be practiced without these specific details. In other instances, well-known structures and devices are schematically shown in order to simplify the drawing.

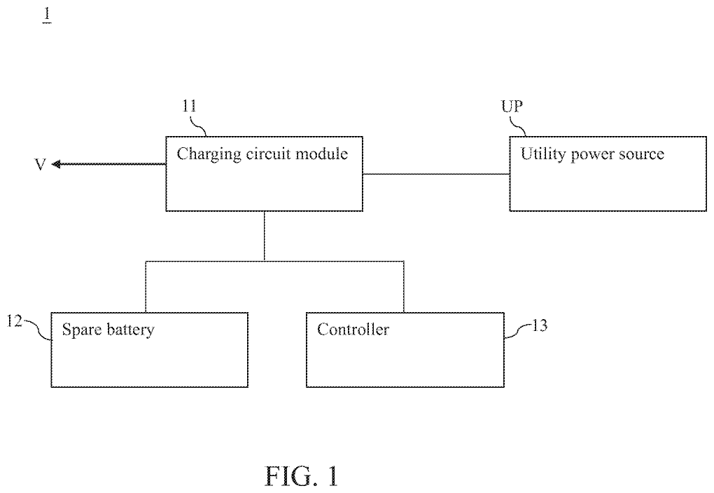

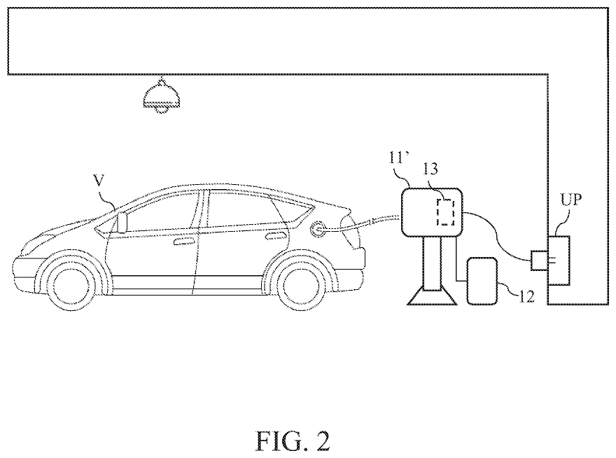

Please refer to FIG. 1 and FIG. 2. FIG. 1 is a block diagram of a charging system for electric vehicles in accordance with a first embodiment of the disclosure; FIG. 2 is a schematic view of the charging system for electric vehicles in accordance with the first embodiment of the disclosure. As shown in FIG. 1, the charging system 1 of the embodiment includes a charging circuit module 11, a spare battery 12 and a controller 13. The charging circuit module 11 is coupled to a utility power source UP. The spare battery 12 is coupled to the charging circuit module 11. In one embodiment, the charging circuit module 11 may be a charging station, a charger, an AC/DC converter, a DC/AC converter or an AC/AC converter, etc. Via the above circuit structure, the controller 13 can control the utility power source UP and the spare battery 12, and charge the spare battery 12 via the utility power source UP.

When the charging circuit module 11 is coupled to the rechargeable battery of a target object (e.g. an electric vehicle) V, the controller 13 can simultaneously controls the utility power source UP and the spare battery 12 via the charging circuit module 11 to charge the rechargeable battery of the target object V, or control only the spare battery 12 via the charging circuit module 11 to charge the rechargeable battery of the target object V. When the spare battery 12 is exhausted, the controller 13 can control the utility power source UP via the charging circuit module 11 to simultaneously charge the rechargeable battery of the target object V and the spare battery 12.

More specifically, the charging and discharging abilities of the spare battery 12 may be greater than or equal to the charging and discharging abilities of the rechargeable battery of the target object V. For the reason, compared with the utility power source UP, the spare battery 12 can charge the rechargeable battery of the target object V more quickly. For instance, the spare battery 12 may be the same with the rechargeable battery of the target object V. Thus, when the spare battery 12 is fully charged, the rechargeable battery of the target object V can be fully charged by the spare battery 12 with a predetermined time period (e.g. 1 hour).

The charging system 1 can not only serve as a household charging system, but also can be applied to an official charging facility so as to realize high charging efficiency, so the charging system 1 is very comprehensive in application.

As shown in FIG. 2, the charging circuit module 11 of the charging system 1 may be a charging station 11′; the charging station 11′ is coupled to the spare battery 12 and the controller 13, and the charging station 11′ may be disposed in the garage of the user's house, and coupled to the utility power source (utility power socket) UP of the garage.

Besides, the charging system 1 can further provide a special power management mechanism. In other words, when the charging system 1 is not coupled to the rechargeable battery of the target object V, the controller 13 can charge the spare battery 12 in proper time periods so as to reduce the electricity cost. More specifically, when the current time is the non-peak power consumption period, the controller 13 can control the charging circuit module 11 to charge the spare battery 12 via the utility power source UP. On the contrary, when the current time is peak power consumption period, the controller 13 can control the charging circuit module 11 to disconnect the utility power source UP from the spare battery 12. Via the above mechanism, the controller 13 can control the utility power source UP to charge the spare batter 12 only in the non-peak power consumption period so as to reduce the electricity cost.

Similarly, when the charging system 11 is coupled to the rechargeable battery of the target object V and the current time is the non-peak power consumption period, the controller 13 can simultaneously control the utility power source UP and the spare battery 12 via the charging circuit module 11 to charge the rechargeable battery of the target object V so as to reduce the time of fully charging the rechargeable battery of the target object V. When the charging system 11 is coupled to the rechargeable battery of the target object V and the current time is the peak power consumption period, the controller 13 can control only the spare battery 12 via the charging circuit module 11 to charge the rechargeable battery of the target object V. Via the above mechanism, the controller 13 can control the utility power source UP to charge the rechargeable battery of the target object V in only the non-peak power consumption period in order to decrease the electricity cost.

The embodiment just exemplifies the present disclosure and is not intended to limit the scope of the present disclosure; any equivalent modification and variation according to the spirit of the present disclosure is to be also included within the scope of the following claims and their equivalents.

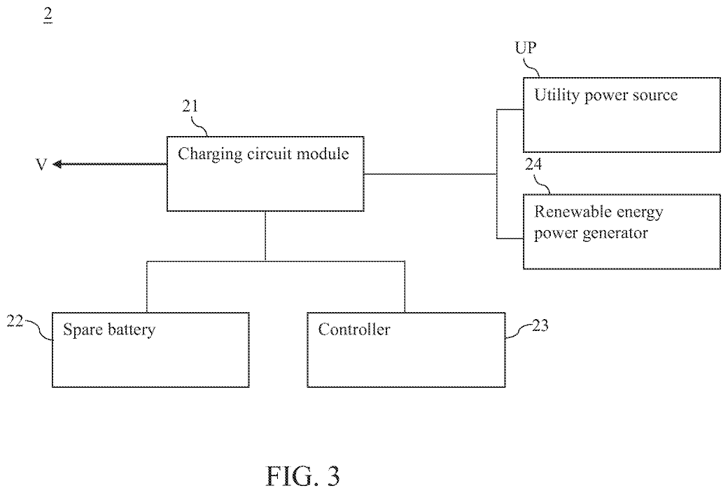

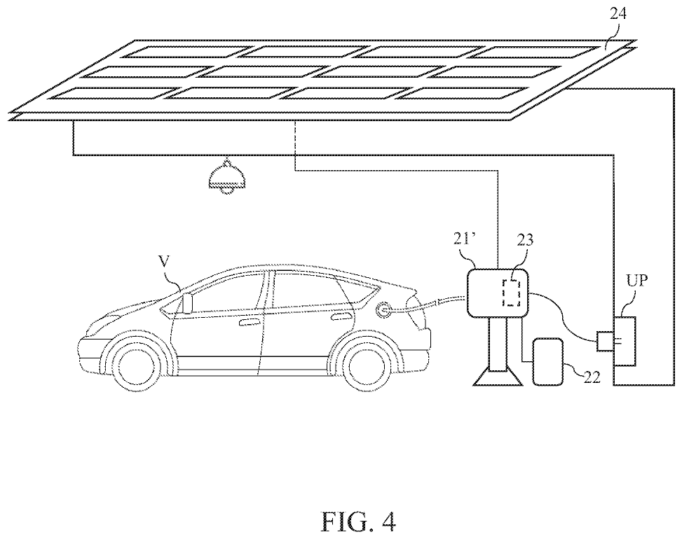

Please refer to FIG. 3 and FIG. 4. FIG. 3 is a block diagram of a charging system for electric vehicles in accordance with a second embodiment of the disclosure; FIG. 4 is a schematic view of the charging system for electric vehicles in accordance with the second embodiment of the disclosure. As shown in FIG. 3, the charging system 2 of the embodiment includes a charging circuit module 21, a spare battery 22 and a controller 23.

The difference between the embodiment and the previous embodiment is that the charging system 2 further includes a renewable energy power generator 24, which is coupled to the charging circuit module 21. When the charging system 2 is not coupled to the rechargeable battery of a target object V, the renewable energy power generator 24 can charge the spare battery 22. In one embodiment, the renewable energy power generator 24 may be a solar generator, wind-driven generator, hydroelectric generator, tidal-power generator, biomass generator or other similar power generators.

When the charging system 2 is coupled to the rechargeable battery of the target object V, the renewable energy power generator 24 can charge the rechargeable battery of the target object V so as to reduce the time of fully charging the rechargeable battery of the target object V and decrease the electricity cost.

As shown in FIG. 4, the charging circuit module 21 of the charging system 2 may be a charging station 21′; the charging station 21′ is coupled to the spare battery 22 and the controller 23, and the charging station 21′ may be disposed in the garage of the user's house, and coupled to the utility power source (utility power socket) UP of the garage.

The charging system 2 can not only serve as a household charging system, but also can be applied to an official charging facility so as to realize high charging efficiency, so the charging system 2 is very comprehensive in application.

The embodiment just exemplifies the present disclosure and is not intended to limit the scope of the present disclosure; any equivalent modification and variation according to the spirit of the present disclosure is to be also included within the scope of the following claims and their equivalents.

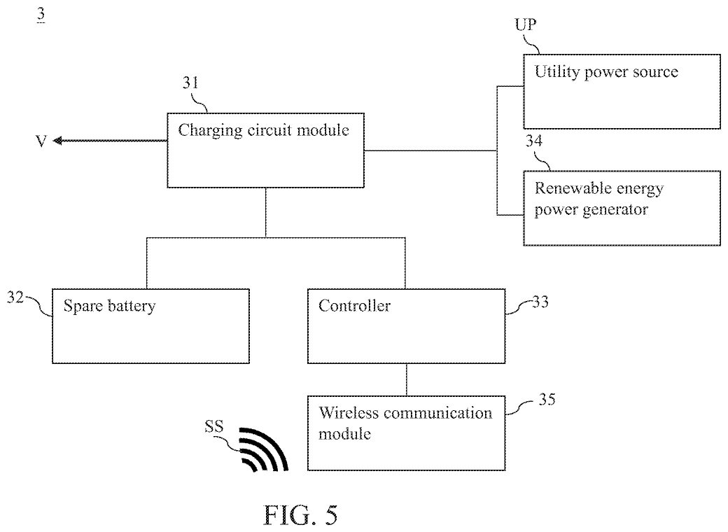

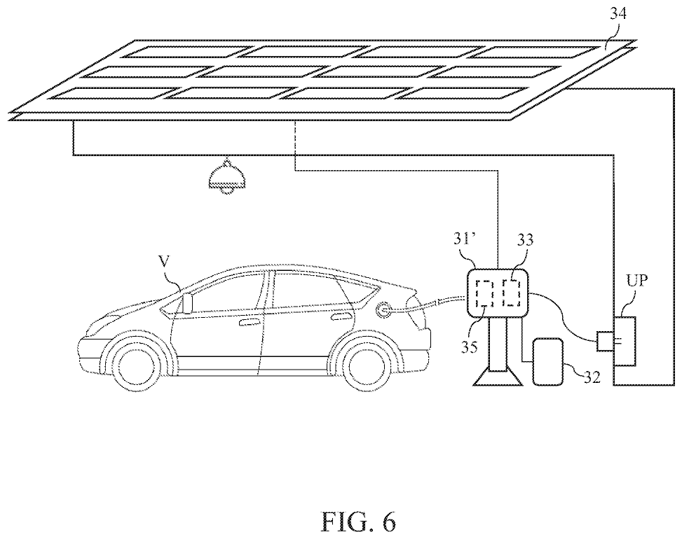

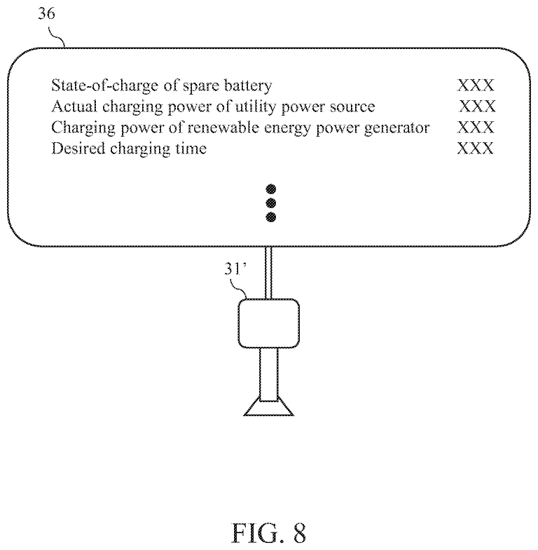

Please refer to FIG. 5 and FIG. 6˜FIG. 8. FIG. 5 is a block diagram of a charging system for electric vehicles in accordance with a third embodiment of the disclosure; FIG. 6˜FIG. 8 are a first schematic view, a second schematic view and a third schematic view of the charging system for electric vehicles in accordance with the third embodiment of the disclosure respectively. As shown in FIG. 5, the charging system 3 of the embodiment includes a charging circuit module 31, a spare battery 32, a controller 33 and a renewable energy power generator 34.

The difference between the embodiment and the previous embodiment is that the charging system 3 further includes a wireless communication module 35. In one embodiment, the wireless communication module 35 may be an antenna or other similar elements.

As shown in FIG. 6, the charging circuit module 31 of the charging system 3 may be a charging station 31′; the charging station 31′ is coupled to the spare battery 32, the controller 33 and the wireless communication module 35 and can be further coupled to the renewable energy power generator 34. The charging station 31′ may be disposed in the garage of the user's house, and coupled to the utility power source (utility power socket) UP of the garage.

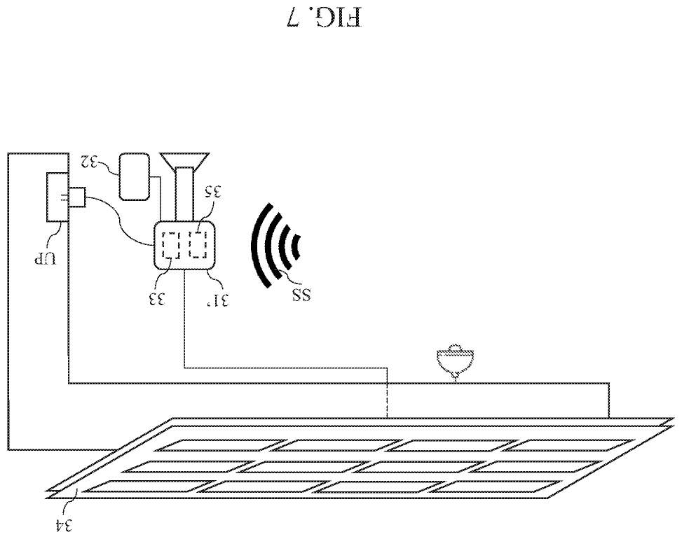

The wireless communication module 35 is coupled to the controller 33, as shown in FIG. 7, when the user drives the target object V and leaves the garage, the controller 33 can receive the battery status information SS of the rechargeable battery of the target object V by the wireless communication module 34 via the wireless network (e.g. Wi-Fi network, mobile communication network, etc.). In the embodiment, the battery status information SS may include the real-time consumed power of the rechargeable battery of the target object V, the power consumption of the rechargeable battery of the target object V and other important information.

When the state-of-charge of the spare battery 32 is greater than or equal to the power consumption of the rechargeable battery of the target object V, the controller 22 can control only the renewable energy power generator 33 via the charging circuit module 31 to charge the spare battery 32. When the state-of-charge of the spare battery 32 is less than the power consumption of the rechargeable battery of the target object V, the controller 33 can execute a dynamic charging management mechanism More specifically, the controller 33 can calculate an ideal total charging power according to the battery status information SS and the state-of-charge of the spare battery 32. Then, the controller 33 can calculate the ideal charging power of the utility power source UP according to the ideal total charging power and the charging power of the renewable energy power generator 34. Afterward, the controller 33 can adjust the actual charging power of the utility power source UP according to the ideal charging power of the utility power source UP.

The controller 33 can calculate the ideal total charging power according to the real-time consumed power of the rechargeable battery of the target object V, the power consumption of the rechargeable battery of the target object V and the state-of-charge of the spare battery 32, as shown in Equation (1):

Pc=Pd+(Ed−Ec)/t (1)

In Equation (1), Pc stands for the ideal total charging power; Pd stands for the real-time consumed power of the rechargeable battery of the target object V; Ed stands for the power consumption of the rechargeable battery of the target object V; Ec stands for the state-of-charge of the spare battery 32; t stands for the desired charging time; the user can adjust the desired charging time according to the actual requirements (e.g. 15 mins, 30 mins or 1 hour).

Next, the controller 33 can calculate the ideal charging power of the utility power source UP according to the ideal total charging power and the charging power of the renewable energy power generator 34, as shown in Equation (2):

Pp=Pc−Pr (2)

In Equation (2), Pp stands for the ideal charging power of the utility power source UP; Pr stands for the charging power of the renewable energy power generator 34.

Finally, the controller 33 can dynamically adjust the actual charging power of the utility power source UP according to the ideal charging power of the utility power source UP, and charge the spare battery 32 via both of the utility power source UP and the renewable energy power generator 34. Via the above dynamic charging management mechanism, the charging system 3 can take full advantage of the electricity provided by the renewable energy power generator 34 and dynamically adjust the actual charging power of the utility power source UP according to the power consumption of the rechargeable battery of the target object V. In this way, the charging system 3 can avoid using the utility power source UP as much as possible and make sure that the state-of-charge of the spare battery 32 is sufficient.

As shown in FIG. 8, the charging system 3 of the embodiment can further include a display screen 36, which can display various information, so the user can obtain a lot of useful information via the display screen 36.

The official charging facility can include several charging stations 31′, spare batteries 32 and controllers 33 and can charge the rechargeable batteries of several target objects V (e.g. electric vehicles). The charging system 3 can not only serve as a household charging system, but also can be applied to an official charging facility so as to realize high charging efficiency, so the charging system 3 is very comprehensive in application.

The embodiment just exemplifies the present disclosure and is not intended to limit the scope of the present disclosure; any equivalent modification and variation according to the spirit of the present disclosure is to be also included within the scope of the following claims and their equivalents.

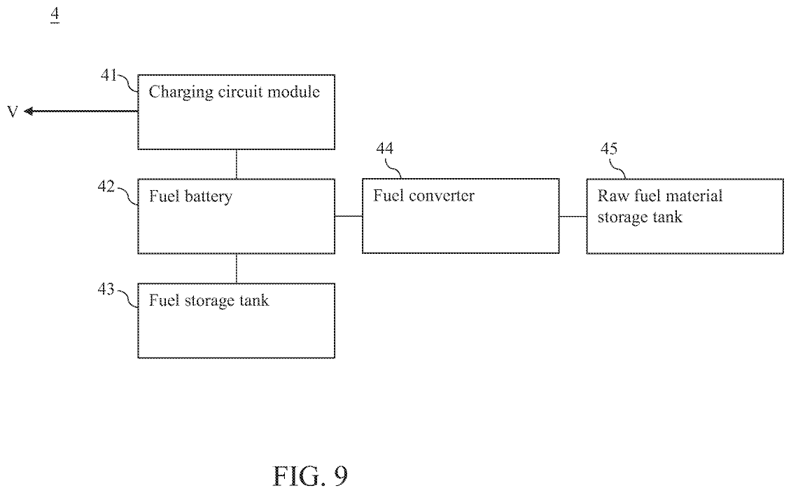

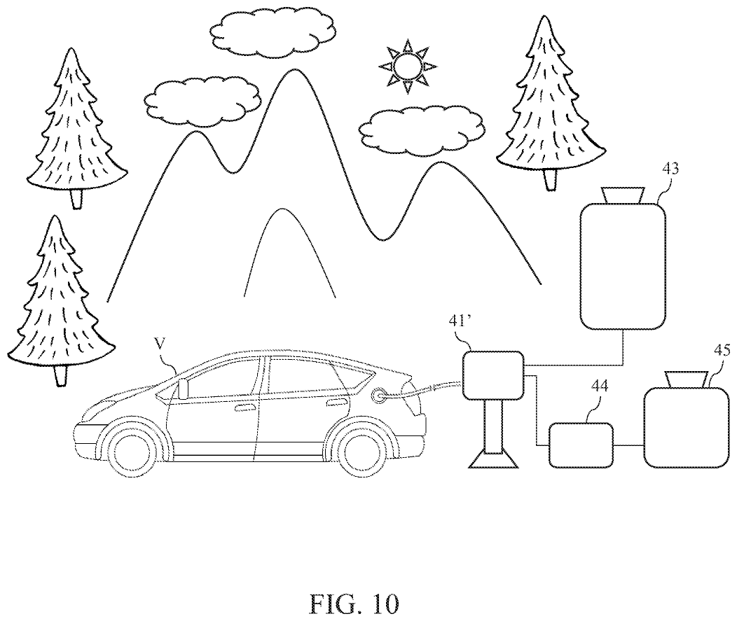

Please refer to FIG. 9 and FIG. 10. FIG. 9 is a block diagram of a charging system for electric vehicles in accordance with a fourth embodiment of the disclosure; FIG. 10 is a schematic view of the charging system for electric vehicles in accordance with the fourth embodiment of the disclosure. As shown in FIG. 9, the charging system 4 of the embodiment includes a charging circuit module 41, a fuel battery 42, a fuel storage tank 43, a fuel converter 44 and a raw fuel material storage tank 45.

The fuel battery 42 can be coupled to the rechargeable battery of a target object V via the charging circuit module 41 in order to charge the rechargeable battery of the target object V. In one embodiment, the fuel battery 42 may be a proton exchange membrane fuel cell (PEMFC), a direct-methanol fuel cell (DMFC), a phosphoric acid fuel cell (PAFC), an alkaline fuel cell (AFC) or other similar fuel cells. Similarly, the charging and discharging abilities of the fuel battery 42 may be greater than or equal to the charging and discharging abilities of the rechargeable battery of the target object V. For the reason, compared with the utility power source UP, the fuel battery 42 can charge the rechargeable battery of the target object V more quickly.

The fuel storage tank 43 can be coupled to the fuel battery 42 and supply the fuel to the fuel battery 42. In one embodiment, the fuel may be hydrogen, liquid hydrogen, methanol, natural gas, propane, marsh gas, etc.

The raw fuel material storage tank 45 is coupled to the fuel converter 44. The raw fuel material storage tank 45 can store the raw fuel material and supply the raw fuel material to the fuel converter 44. In one embodiment, the raw fuel material may be methane, natural gas, animal excrement etc.

The fuel converter 44 is coupled to the fuel battery 42. The fuel converter 44 can convert the raw fuel material into the fuel and then supply the fuel to the fuel battery 42.

As described above, as the charging and discharging abilities of the fuel battery 42 may be greater than or equal to the charging and discharging abilities of the rechargeable battery of the target object V, so the fuel battery 42 can quickly charge the rechargeable battery of the target object V. In addition, as the charging system 4 integrates the fuel battery 42, the fuel storage tank 43, the fuel converter 33 and the raw fuel material storage tank 45, so can be used in a remote district without power supply facility.

As shown in FIG. 10, the charging circuit module 41 of the charging system 4 may be a charging station 41′; the charging station 41′ is coupled to the fuel battery 42 and further coupled to the fuel storage tank 43, the fuel converter 44 and the raw fuel material storage tank 45. The charging station 41′ can be installed at any place without power supply facility.

Via the above mechanism, the fuel storage tank 43 and the fuel converter 44 can automatically supply the fuel to the fuel battery 42, and the user can also manually supply the fuel to the fuel battery 42 in order to make sure that the charging system 4 can work normally.

The embodiment just exemplifies the present disclosure and is not intended to limit the scope of the present disclosure; any equivalent modification and variation according to the spirit of the present disclosure is to be also included within the scope of the following claims and their equivalents.

To sum up, according to the embodiments of the disclosure, the charging system can be installed in the house of the user and include the spare battery; besides, the charging system can be also coupled to the utility power source, so the electric vehicle can be charged only by the spare battery or charged by both of the spare battery and the utility power source, which can significantly increase the efficiency of charging the electric vehicle.

According to the embodiments of the disclosure, the charging system provides the special power management mechanism, which can avoid that the spare battery or the rechargeable battery of the target object is charged by the utility power source during the peak power consumption period. Thus, the charging system can reduce the electricity cost and effectively decrease the cost of charging the electric vehicle.

Also, according to the embodiments of the disclosure, the charging system includes the renewable energy power generator, which can produce electricity by natural resources, so can reduce the electricity cost and further decrease the cost of charging the electric vehicle.

Besides, according to the embodiments of the disclosure, the charging system provides the special dynamic charging management mechanism, which can dynamically adjust the actual charging power of the utility power source according to the battery status information of the rechargeable battery of the target object. Therefore, the charging system can not only make sure that the rechargeable battery of the target object can be fully charged within a predetermined time period, but also can further reduce the electricity cost in order to achieve energy saving and carbon reduction

Moreover, according to the embodiments of the disclosure, the charging system can be applied to official charging facilities, so not only can make sure that the official charging facilities can obtain enough power supply without special electrical license, but also can effectively reduce the cost of the official charging facilities.

Furthermore, according to the embodiments of the disclosure, the charging system can integrate the fuel battery, the fuel storage tank and the fuel converter, so can be applied to remote districts without power supply facility, which is more convenient in use.

It will be apparent to those skilled in the art that various modifications and variations can be made to the disclosed exemplary embodiments. It is intended that the specification and examples be considered as exemplary only, with a true scope of the disclosure being indicated by the following claims and their equivalents.

What is claimed is:

1. A charging system for electric vehicles, comprising:
a charging circuit module, coupled to a utility power source;
a spare battery, coupled to the charging circuit module; and
a controller, configured to control the utility power source and the spare battery via the charging circuit module.

2. The charging system of claim 1, wherein when a current time is within a non-peak power consumption period, the controller controls the charging circuit module to charge the spare battery via the utility power source.

3. The charging system of claim 1, wherein when a current time is within a peak power consumption period, the controller controls the charging circuit module to disconnect the utility power source from the spare battery.

4. The charging system of claim 1, wherein when a current time is within a non-peak power consumption period and the charging circuit module is coupled to a rechargeable battery of a target object, the controller controls the charging circuit module to charge the rechargeable battery of the target object via the utility power source and the spare battery.

5. The charging system of claim 1, wherein when a current time is within a peak power consumption period and the charging circuit module is coupled to a rechargeable battery of a target object, the controller controls the charging circuit module to charge the rechargeable battery of the target object via the spare battery.

6. The charging system of claim 1, further comprising a renewable energy power generator coupled to the charging circuit module for charging the spare battery.

7. The charging system of claim 6, further comprising a wireless communication module coupled to the controller, wherein the controller receives a battery status information of a rechargeable battery of a target object via the wireless communication module.

8. The charging system of claim 7, wherein the controller calculates an ideal total charging power according to the battery status information and a state-of-charge of the spare battery, and calculates an ideal charging power of the utility power source according to the ideal total charging power and a charging power of the renewable energy power generator, and adjusts an actual charging power of the utility power source according to the ideal charging power of the utility power source.

9. A charging system for electric vehicles, comprising:
a charging circuit module;
a fuel battery, coupled to a rechargeable battery of a target object via the charging circuit module in order to charge the rechargeable battery of the target object;
a fuel storage tank, coupled to the fuel battery and supply a fuel to the fuel battery; and
a fuel converter, configured to convert a raw fuel material into the fuel and supply the fuel to the fuel battery.

10. The charging system of claim 9, further comprising a raw fuel material storage tank, coupled to the fuel converter and store the raw fuel material and supply the raw fuel material to the fuel converter.
